(19) United States
(12) Patent Application Publication
(10) Pub. No.: US 2005/0025936 A1
(43) Pub. Date: Feb. 3, 2005

(54) Nonwoven cleaning articles having intercalated three-dimensional images

(76) Inventors: Jerry Snider, Raleigh, NC (US); Julia A. Thompson, Los Alamos, NM (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/820,985

(22) Filed: Apr. 8, 2004

Related U.S. Application Data
(63) Continuation of application No. 60/462,076, filed on Apr. 11, 2003.

(51) Int. Cl. B32B 3/00

(52) U.S. Cl. 428/156

(57) ABSTRACT

The present invention is directed to a method of making a nonwoven cleaning article, which exhibits a plurality of three-dimensional images whereby the fabric is comprised of at least a first and second three-dimensional image that are dissimilar from one another. The three-dimensional images may be imparted into the fabric in a co-planar arrangement, multi-planar arrangement, or by utilizing both arrangements within the same fabric. Further, the present invention contemplates a cleaning article comprised of a plurality of three-dimensional images which can provide the fabric with various physical and/or aesthetic performances.

### TECHNICAL FIELD

The present invention relates generally to methods of making nonwoven cleaning articles, and more particularly, to a method of manufacturing a nonwoven cleaning article comprising a plurality of interposed three-dimensional images whereby the cleaning article incorporates at least a first and a second three-dimensional image, said first three-dimensional image exhibiting a different performance and/or aesthetic attribute than said second three-dimensional image, wherein said first three-dimensional image is immediately presented within the second three-dimensional image.

### BACKGROUND OF THE INVENTION

Nonwoven fabrics are suitable for use in a wide variety of applications where the efficiency with which the fabrics can be manufactured provides a significant economic advantage for nonwoven fabrics versus traditional textiles. The general use of nonwoven fabrics as cleaning and cleansing articles is well known in the art. Various end-use articles are commercially available which utilize a combination of topical, performance enhancing additives and/or multi-layered laminate constructions. Enhanced versions of articles used in cleaning applications further incorporate an optional cleaning fluid, including but not limited to, soaps, lotions, disinfectants, polishing solutions, and glass cleaners.

More recently, so as to improve the aesthetic, as well as performance quality of the nonwoven cleaning article, hydroentanglement techniques have been developed which impart images or patterns to the entangled fabric by effecting hydroentanglement on three-dimensional image transfer devices. Such three-dimensional image transfer devices are disclosed in U.S. Pat. No. 5,098,764, which is hereby incorporated by reference; with the use of such image transfer devices being desirable for providing a fabric with enhanced physical properties as well as an aesthetically pleasing appearance.

In circumstances whereby a single three-dimensional image is incapable or incongruous with satisfying the physical or aesthetic performances required, an unmet need exists for a product which exhibits two or more three-dimensional images, each image having different aesthetic or performance attributes. Further, it has been found that a multi-step fabrication process whereby a first image is imparted, followed by the application of a second image, is exceedingly problematic due to issues of registering the two different images, and changes in the ability of the constituent fibrous matrix to receive pronounced changes in three-dimensionality without obscuring the first imparted image. In addition, microporous drums, as well as, woven and/or embossed belts do not provide for sufficient finite fiber control to allow for the creation of high quality, useable materials. It is, therefore, an objective of the present invention to provide a method of making a nonwoven cleaning article whereby the article comprises at least a first and a second three-dimensional image, said first three-dimensional image exhibiting a different performance and/or aesthetic attribute than said second three-dimensional image, wherein said first three-dimensional image is intercalated immediately within the second three-dimensional image. The nonwoven cleaning article of the present invention is suitable for numerous home, medical and hygiene end-uses applications.

### SUMMARY OF THE INVENTION

The present invention is directed to a method of making a nonwoven cleaning article, which exhibits a plurality of three-dimensional images whereby the fabric is comprised of at least a first and second three-dimensional image that are dissimilar from one another. The three-dimensional images may be imparted into the fabric in a co-planar arrangement, multi-planar arrangement, or by utilizing both arrangements within the same fabric. Further, the present invention contemplates a cleaning article comprised of a plurality of three-dimensional images which can provide the fabric with various physical and/or aesthetic performances, for example; the first three-dimensional image may provide a physical performance, such as exfoliation or particulate entrainment, and the second three-dimensional image may serves as an aesthetic enhancement. It is also within the purview of the present invention that the first and second three-dimensional images may both provide a performance or an aesthetic enhancement. A particular representative nonwoven cleaning article whereby two separate three-dimensional images, each image providing a different physical performance, are intercalated to form a material with a new or different performance is the combination of a first three-dimensional image providing exfoliation and a second three-dimensional image providing enhanced lather generation.

In accordance with the present invention, a method of making a nonwoven cleaning article includes the steps of providing a precursor web comprising a fibrous matrix. While use of staple length fibers is typical, the fibrous matrix may comprise substantially continuous filaments. In a particularly preferred form, the fibrous matrix comprises staple length fibers, which are carded and cross-lapped to form a precursor web. In one embodiment, the nonwoven fabric is a composite or laminate structure wherein the precursor web is comprised of one or more additional nonwoven layers, such as a support layer, a woven layer, such as a knit, or a film layer, such as a monolithic film.

In a particular embodiment envisioned by the present invention, the intercalated co-planar and/or multi-planar three-dimensional images of the resultant nonwoven fabric are adjoined to the background image of the fibrous substrate through fibrous bundles, referred to as fibrous transitions regions as specifically described in U.S. Pat. No. 5,674,591 to James et al., which is hereby incorporated by reference.

In a third embodiment, the nonwoven fabric of the invention comprises two different intercalated three-dimensional images, wherein at least one three-dimensional image comprises a repeating pattern of one or more apertures. The apertures may extend entirely or partially through the substrate, and/or may be distributed in an organized fashion or randomly scattered through out the resultant nonwoven cleaning article.

In a forth embodiment, the nonwoven cleaning article of the invention comprises two different intercalated three-dimensional images, wherein one said three-dimensional image imparts a first woven or knit pattern and one said three-dimensional image imparts a different woven or knit pattern. For example, the present invention is capable of forming a nonwoven fabric having both left-hand and right-hand woven twill aesthetic properties interspersed throughout the continuous surface of the fabric, as represented in FIG. 16, or left-hand woven twill and tricot knit aesthetic properties, as represented in FIG. 17.

Subsequent to hydroentanglement, the three-dimensionally imaged cleaning article may be subjected to one or more variety of post-entanglement performance modifying treatments. Such treatments may include application of a polymeric binder composition, mechanical compacting, application of surfactant or electrostatic compositions, printing or dyeing, and like processes.

Subsequent to three-dimensional imaging, the imaged nonwoven cleaning article is treated with one or more performance or aesthetic modifying composition to further alter the fabric structure or to meet end-use article requirements. A polymeric binder composition can be selected to enhance durability characteristics of the fabric, while maintaining the desired softness and drapeability of the three-dimensionally imaged fabric. A surfactant can be applied so as to impart hydrophilic properties. In addition, electrostatic modifying compound can be used to aid in cleaning or dusting applications.

Other features and advantages of the present invention will become readily apparent from the following detailed description, the accompanying drawings, and the appended claims.

### BRIEF DESCRIPTION OF THE DRAWINGS

FIG. 1 is a diagrammatic view of an apparatus for manufacturing a durable nonwoven fabric, embodying the principles of the present invention;

FIG. 2 is a photomicrograph of the fabric herein described in the present invention;

FIG. 3 is a photomicrograph of the fabric herein described in the present invention;

FIG. 4 is a photomicrograph of the fabric herein described in the present invention;

FIG. 5 is a photomicrograph of the prior art nonwoven fabric;

FIG. 6 is a photomicrograph of the fabric herein described in the present invention;

FIG. 7 is a photomicrograph of the fabric herein described in the present invention;

FIG. 8 is a photomicrograph of the fabric herein described in the present invention;

FIG. 9 is a photomicrograph of the prior art nonwoven fabric;

FIG. 10 is a photomicrograph of the fabric herein described in the present invention;

FIG. 11 is a photomicrograph of the fabric herein described in the present invention;

FIG. 12 is a photomicrograph of the fabric herein described in the present invention;

FIG. 13 is a photomicrograph of the fabric herein described in the present invention;

FIG. 14 is a photomicrograph of the fabric herein described in the present invention;

FIG. 15 is a photomicrograph of the fabric herein described in the present invention;

FIG. 16 is a top plan view of an image transfer device having a left-hand woven twill three-dimensional aesthetic property intercalated with a right-hand woven twill three-dimensional aesthetic property; and

FIG. 17 is a top plan view of an image transfer device having a left-hand woven twill three-dimensional aesthetic property intercalated with tricot knit three-dimensional aesthetic property.

### DETAILED DESCRIPTION

While the present invention is susceptible of embodiment in various forms, there is shown in the drawings, and will hereinafter be described, a presently preferred embodiment of the invention, with the understanding that the present disclosure is to be considered as an exemplification of the invention, and is not intended to limit the invention to the specific embodiment illustrated.

The present invention is directed to a method of forming a nonwoven cleaning article comprised of a plurality of three-dimensional images comprising at least a first three-dimensional image and a second three-dimensional image whereby the first and second three-dimensional images are dissimilar.

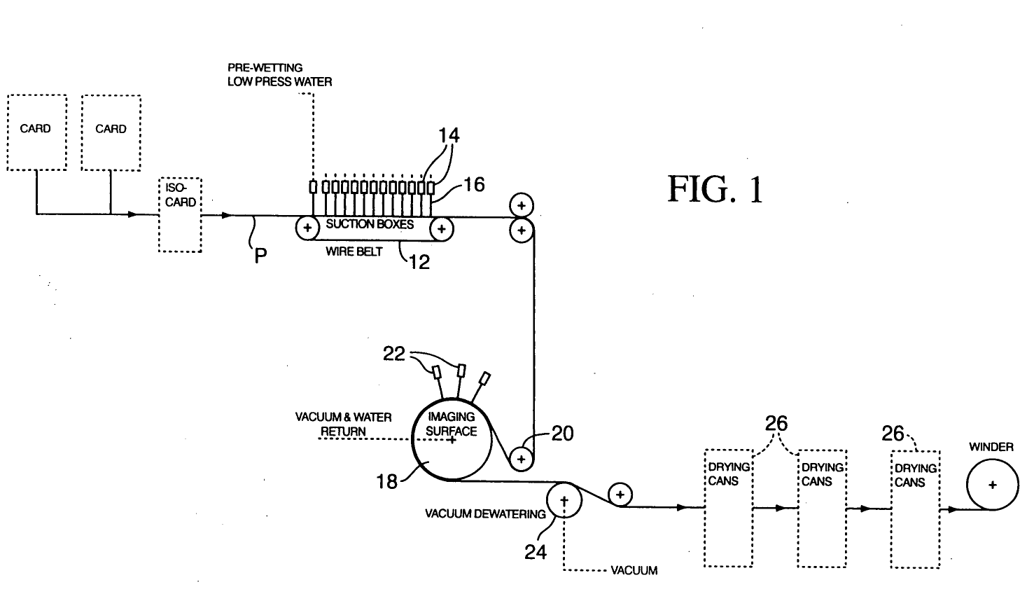

With reference to FIG. 1, therein is illustrated an apparatus for practicing the present method for forming a nonwoven cleaning article. The article is formed from a fibrous matrix, which typically comprises staple length fibers, but may comprise substantially continuous filaments. The fibrous matrix is preferably carded and cross-lapped to form a fibrous batt, designated F. In a current embodiment, the fibrous batt comprises 100% cross-lap fibers, that is, all of the fibers of the web have been formed by cross-lapping a carded web so that the fibers are oriented at an angle relative to the machine direction of the resultant web. U.S. Pat. No. 5,475,903, hereby incorporated by reference, illustrates a web drafting apparatus.

The apparatus of the present invention includes a foraminous forming surface in the form of a flat bed entangler 12 upon which the precursor web P is positioned for pre-entangling. Precursor web P is then sequentially passed under entangling manifolds 14, whereby the precursor web is subjected to high-pressure water jets 16. This process is well known to those skilled in the art and is generally taught by U.S. Pat. No. 3,485,706, to Evans, hereby incorporated by reference.

The entangling apparatus of FIG. 1 further includes an imaging and patterning drum 18 comprising a three-dimensional image transfer device for effecting imaging and patterning of the now-entangled precursor web. The three-dimensional image transfer device of the present invention comprises at least two dissimilar images embedded within the imaging movable surface. After pre-entangling, the precursor web is trained over a guide roller 20 and directed to the image transfer device 18, where a plurality of three-dimensional images are imparted into the fabric on the foraminous forming surface of the device. The web of fibers is juxtaposed to the image transfer device 18, and high pressure water from manifolds 22 is directed against the outwardly facing surface from jet spaced radially outwardly of the image transfer device 18. The image transfer device 18, and manifolds 22, may be formed and operated in accordance with the teachings of commonly assigned U.S. Pat. No. 4,098,764, U.S. Pat. No. 5,244,711, U.S. Pat. No. 5,822,823, and U.S. Pat. No. 5,827,597, the disclosures of which are hereby incorporated by reference. The entangled fabric can be vacuum dewatered at 24, and dried at an elevated temperature on drying cans 26.

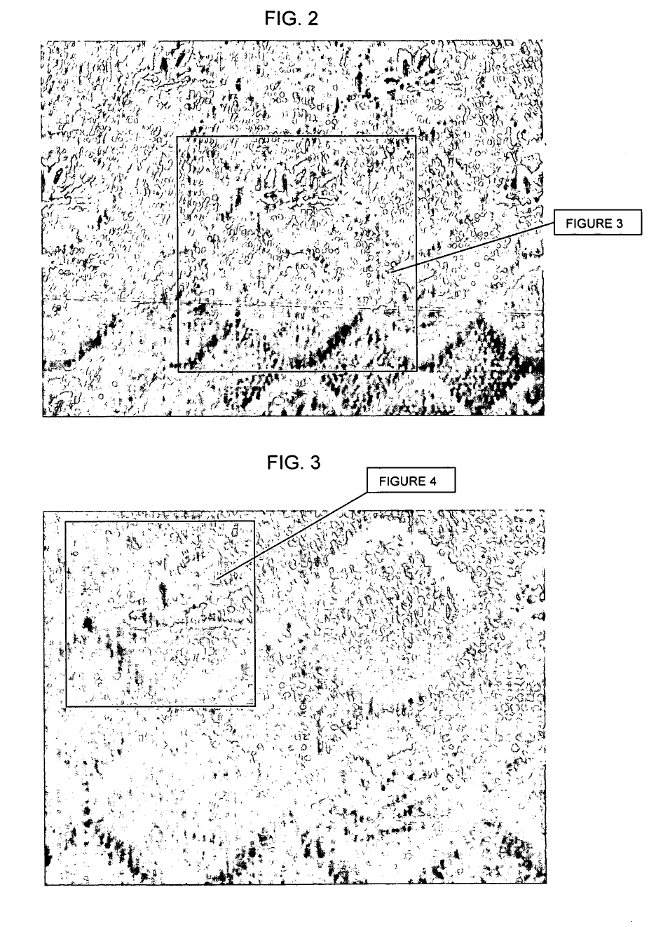

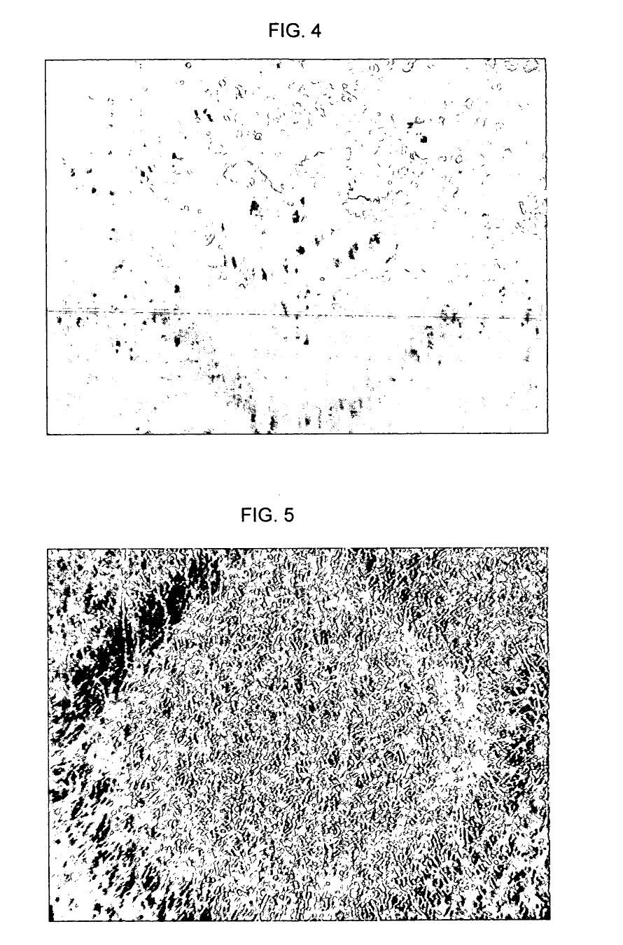

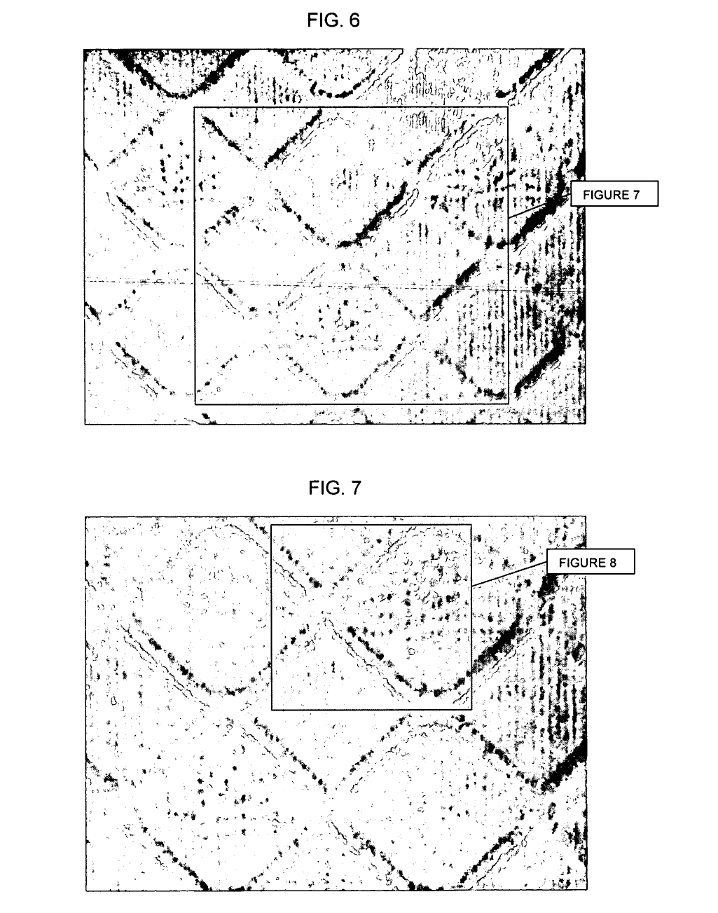

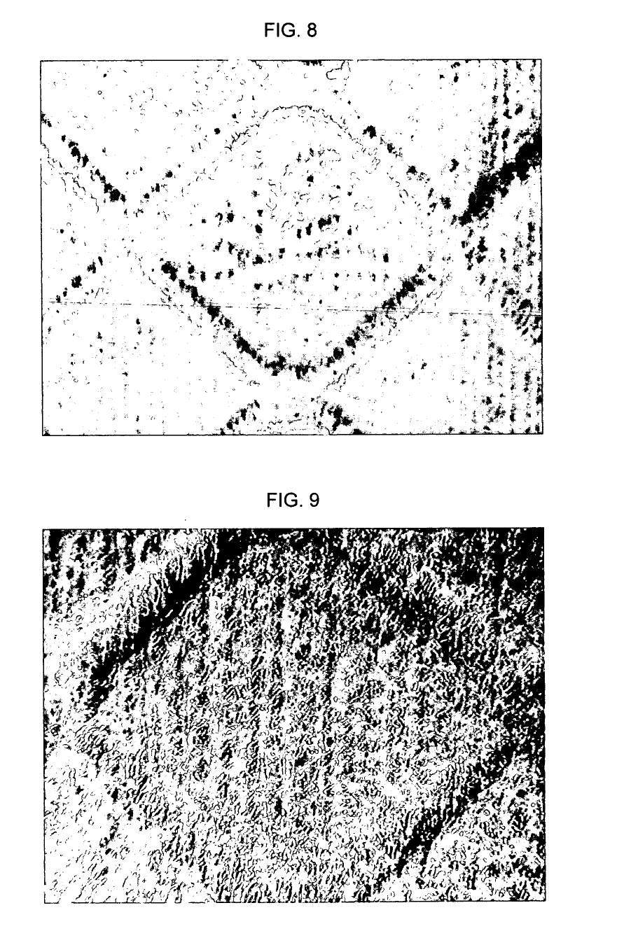

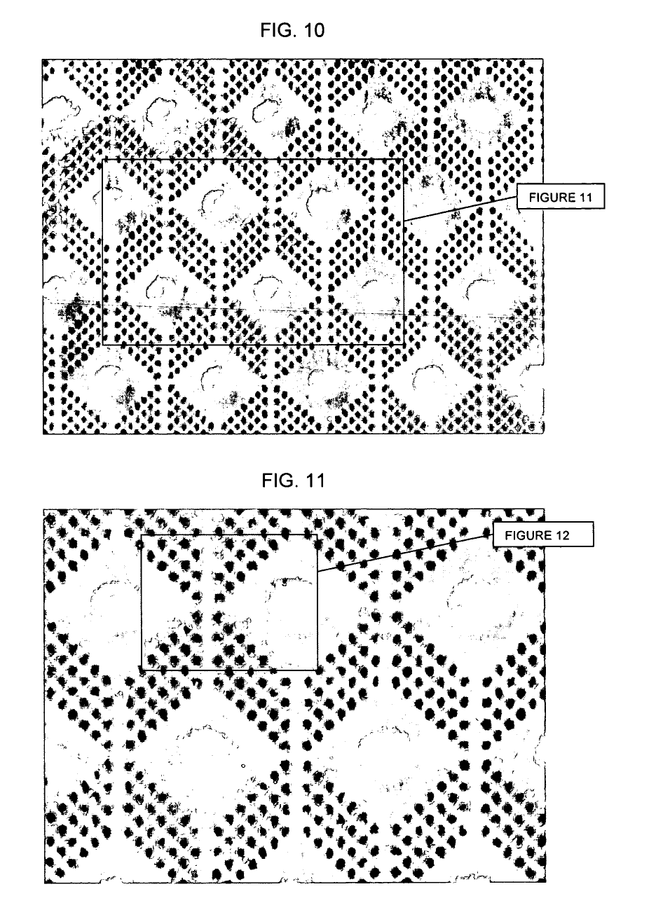

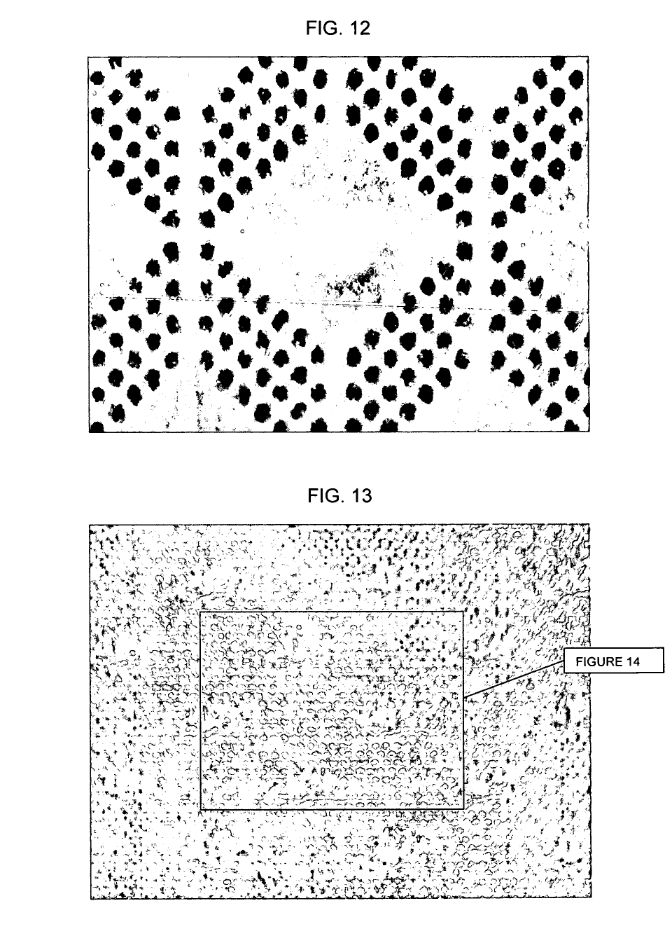

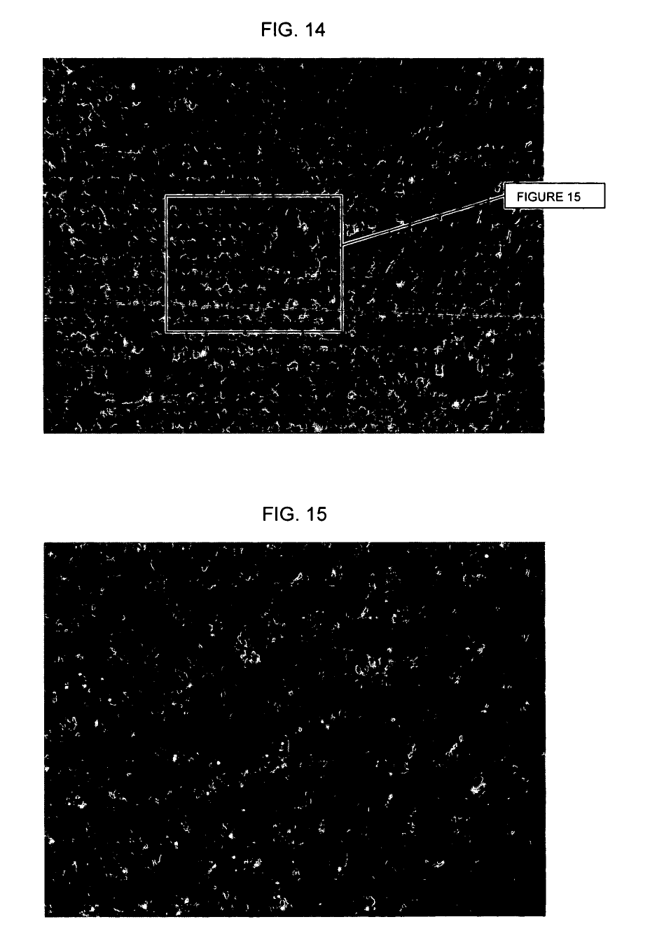

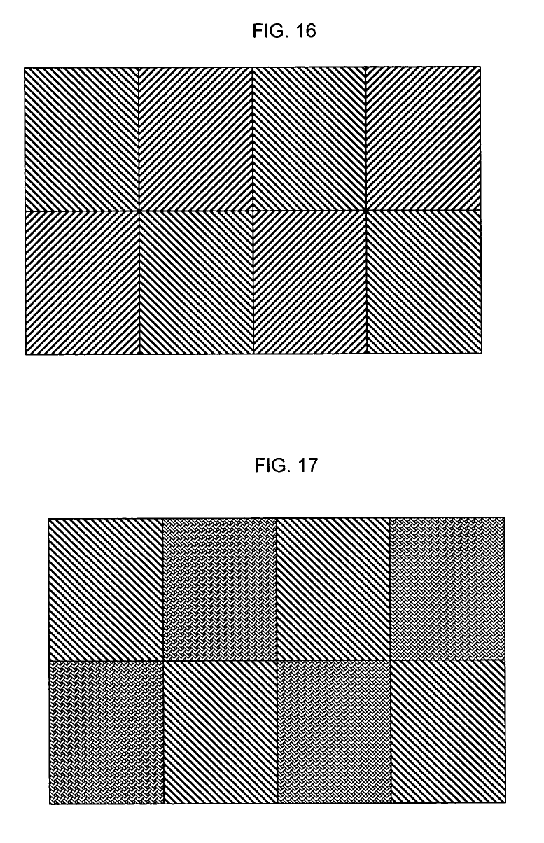

The nonwoven cleaning article of the present invention may be a composite, laminate, single layer or multiple layers in order to incorporate support and/or absorbent mechanisms into the imaged article. The plurality of three-dimensional images can provide the fabric with various attributes, for example, the first three-dimensional image may provide a performance attribute and the second three-dimensional image may serves as an aesthetic enhancement, the first and second three-dimensional images may both provide a performance, wherein the two different images may have the same or different performance, or the first and second three-dimensional images may both provide for aesthetic enhancement of the over all resultant nonwoven cleaning article. FIGS. 2 through 17 are photomicrographs of the representative fabrics of the present invention.

The plurality of three-dimensional images intercalated within the nonwoven article can be arranged either co-planar to one another, multi-planar to one another, or arranged co-planar as well as multi-planar to one another. Optionally, the intercalated three-dimensional images of the resultant nonwoven cleaning article can be adjoined to the background of the fibrous substrate or adjoined to an underlying three-dimensional image through fibrous bundles, referred to as fibrous transitions regions as previously mentioned.

It is within the purview of present invention that the nonwoven cleaning article can comprises two different intercalated three-dimensional images, wherein at least one three-dimensional image comprises a repeating pattern of one or more apertures. The apertures may extend entirely or partially through the substrate, and/or may be distributed in an organized fashion or randomly scattered through out the resultant nonwoven cleaning article.

The nonwoven article can be further modified aesthetically through subsequent dyeing, and printing, or by using colored fibers during the manufacturing step, to achieve the affects of the desired nonwoven cleaning article.

Manufacture of a nonwoven cleaning article comprised of a plurality of three-dimensional images embodying the principles of the present invention is initiated by providing the fibrous matrix, which can include the use of staple length fibers, continuous filaments, and the blends of fibers and/or filaments having the same or different composition. Fibers and/or filaments are selected from natural or synthetic composition, of homogeneous or mixed fiber length. Suitable natural fibers include, but are not limited to, cotton, reconstituted cotton, wood pulp and viscose rayon. Synthetic fibers, which may be blended in whole or part, include thermoplastic and thermoset polymers. Thermoplastic polymers suitable for blending with dispersant thermoplastic resins include polyolefins, polyamides and polyesters. The thermoplastic polymers may be further selected from homopolymers; copolymers, conjugates and other derivatives including those thermoplastic polymers having incorporated melt additives or surface-active agents. Staple lengths are selected in the range of 0.25 inch to 10 inches, the range of 1 to 3 inches being preferred and the fiber denier selected in the range of 1 to 22, the range of 2.0 to 8 denier being preferred for general applications. The profile of the fiber and/or filament is not a limitation to the applicability of the present invention.

In accordance with the present invention, the nonwoven cleaning article includes the use of various aqueous and non-aqueous compositions. The cleaning article embodying the principles of the present invention is especially suitable for home care cleaning or cleansing articles. The nonwoven article may be used in various home care applications, wherein the end use article may be a dry or wet hand held sheet, such as a wipe, a mitt formation, or a cleaning implement capable of retaining the article. The various end uses suitable for cleaning household surfaces such as, kitchen and bathroom countertops, sinks, bathtubs, showers, appliances, and fixtures.

Cleansing compositions suitable for such end use applications include those that are described in U.S. Pat. No. 6,103,683 to Romano, et al., U.S. Pat. No. 6,340,663 to Deleo, et al., U.S. Pat. No. 5,108,642 to Aszman, et al., and U.S. Pat. No. 6,534,472 Arvanitidou, et al., all of which are hereby incorporated by reference. Selected cleaning compositions may also include surfactants, such as alkylpolysaccharides, alkyl ethoxylates, alkyl sulfonates, and mixtures thereof; organic solvent, mono- or polycarboxylic acids, odor control agents, such as cyclodextrin, peroxides, such as benzoyl peroxide, hydrogen peroxide, and mixtures thereof, thickening polymers, aqueous solvent systems, suds suppressors, perfumes or fragrances, and detergent adjuvants, such as detergency builder, buffer, preservative, antibacterial agent, colorant, bleaching agents, chelants, enzymes, hydrotropes, and mixtures thereof. The aforementioned compositions preferably comprise from about 50% to about 500%, preferably from about 200% to about 400% by weight of the nonwoven cleaning article.

The cleaning article embodying the principles of the present invention is also suitable for personal cleaning or cleansing articles. Non-limiting examples of such applications include dry or wet facial wipes, body wipes, and baby wipes. Suitable methods for the application of various aqueous and non-aqueous compositions comprise aqueous/alcoholic impregnates, including flood coating, spray coating or metered dosing. Further, more specialized techniques, such as Meyer Rod, floating knife or doctor blade, which are typically used to impregnate cleansing solutions into absorbent sheets, may also be used. The following compositions preferably comprise from about 50% to about 500%, preferably from about 200% to about 400% by weight of the nonwoven cleaning article.

The nonwoven laminate incorporates a functional additive, such as an alpha-hydroxycarboxylic acid, which refers not only the acid form but also salts thereof. Typical cationic counterions to form the salt are the alkali metals, alkaline earth metals, ammonium, C₂-C₈ trialkanolammonium cation and mixtures thereof. The term “alpha-hydroxycarboxylic acids” include not only hydroxyacids but also alpha-ketoacids and related compounds of polymeric forms of hydroxyacid.

Amounts of the alpha-hydroxycarboxylic acids may range from about 0.01 to about 20%, preferably from about 0.1 to about 15%, more preferably from about 1 to about 10%, optimally from about 3 to about 8% by weight of the composition which impregnates the substrate. The amount of impregnating composition relative to the substrate may range from about 20:1 to 1:20, preferably from 10:1 to about 1:10 and optimally from about 2:1 to about 1:2 by weight

Further, a humectant may be incorporated with the aforementioned alpha-hydroxycarboxylic compositions. Humectants are normally polyols. Representative polyols include glycerin, diglycerin, polyalkylene glycols and more preferably alkylene polyols and their derivatives. Amounts of the polyol may range from about 0.5 to about 95%, preferably from about 1 to about 50%, more preferably from about 1.5 to 20%, optimally from about 3 to about 10% by weight of the impregnating composition.

A variety of cosmetically acceptable carrier vehicles may be employed although the carrier vehicle normally will be water. Amounts of the carrier vehicle may range from about 0.5 to about 99%, preferably from about 1 to about 80%, more preferably from about 50 to about 70%, optimally from about 65 to 75% by weight of the impregnating composition.

Preservatives can desirably be incorporated protect against the growth of potentially harmful microorganisms. Suitable traditional preservatives for compositions of this invention are alkyl esters of para-hydroxybenzoic acid. Other preservatives which have more recently come into use include hydantoin derivatives, propionate salts, and a variety of quaternary ammonium compounds. Preservatives are preferably employed in amounts ranging from 0.01% to 2% by weight of the composition.

The cosmetic composition may further include herbal extracts. Illustrative extracts include Roman Chamomile, Green Tea, Scullcap, Nettle Root, Swertia laponica, Fennel and Aloe Vera extracts. Amount of each of the extracts may range from about 0.001 to about 1%, preferably from about 0.01 to about 0.5%, optimally from about 0.05 to about 0.2% by weight of a composition.

Additional functional cosmetic additives may also include vitamins such as Vitamin E Acetate, Vitamin C, Vitamin A Palmitate, Panthenol and any of the Vitamin B complexes. Anti-irritant agents may also be present including those of steviosides, alpha-bisabolol and glycyhrizzinate salts, each vitamin or anti-irritant agent being present in amounts ranging from about 0.001 to about 1.0%, preferably from about 0.01 to about 0.3% by weight of the composition.

These impregnating compositions of the present invention may involve a range of pH although it is preferred to have a relatively low pH, for instance, a pH from about 2 to about 6.5, preferably from about 2.5 to about 4.5.

In addition to cosmetic compositions, lotions may be incorporated into the nonwoven cleaning article. The lotion preferably also comprises one or more of the following: an effective amount of a preservative, an effective amount of a humectant, an effective amount of an emollient; an effective amount of a fragrance, and an effective amount of a fragrance solubilizer.

As used herein, an emollient is a material that softens, soothes, supples, coats, lubricates, or moisturizes the skin. The term emollient includes, but is not limited to, conventional lipid materials (e.g. fats, waxes), polar lipids (lipids that have been hydrophylically modified to render them more water soluble), silicones, hydrocarbons, and other solvent materials. Emollients useful in the present invention can be petroleum based, fatty acid ester type, alkyl ethoxylate type, fatty acid ester ethoxylates, fatty alcohol type, polysiloxane type, mucopolysaccharides, or mixtures thereof.

Humectants are hygroscopic materials that function to draw water into the stratum comeum to hydrate the skin. The water may come from the dermis or from the atmosphere. Examples of humectants include glycerin, propylene glycol, and phospholipids.

Fragrance components, such as perfumes, include, but are not limited to water insoluble oils, including essential oils. Fragrance solubilizers are components which reduce the tendency of the water insoluble fragrance component to precipitate from the lotion. Examples of fragrance solubilizers include alcohols such as ethanol, isopropanol, benzyl alcohol, and phenoxyethanol; any high HLB (HLB greater than 13) emulsifier, including but not limited to polysorbate; and highly ethoxylated acids and alcohols.

Preservatives prevent the growth of micro-organisms in the liquid lotion and/or the substrate. Generally, such preservatives are hydrophobic or hydrophilic organic molecules. Suitable preservatives include, but are not limited to parabens, such as methyl parabens, propyl parabens, and combinations thereof.

The lotion can also comprise an effective amount of a kerotolytic for providing the function of encouraging healing of the skin. An especially preferred kerotolytic is Allantoin ((2,5-Dioxo-4-Imidazolidinyl)Urea), a heterocyclic organic compound having an empirical formula C₄ H₆ N₄ O₃. Allantoin is commercially available from Tri-K Industries of Emerson, New Jersey. It is generally known that hyperhydrated skin is more susceptible to skin disorders, including heat rash, abrasion, pressure marks and skin barrier loss. A pre-moistened wipe according to the present invention can include an effective amount of allantoin for encouraging the healing of skin, such as skin which is over hydrated.

U.S. Pat. No. 5,534,265 issued Jul. 9, 1996; U.S. Pat. No. 5,043,155 issued Aug. 27, 1991; and U.S. Pat. No. 5,648,083 issued Jul. 15, 1997 are incorporated herein by reference for the purpose of disclosing additional lotion ingredients.

The lotion can further comprise between about 0.1 and about 3 percent by eight Allantoin, and about 0.1 to about 10 percent by weight of an aloe extract, such as aloe vera, which can serve as an emollient. Aloe vera extract is available in the form of a concentrated powder from the Rita Corporation of Woodstock, Ill.

Further, latherants may be incorporated within the cleaning article. Non-limiting examples of anionic lathering surfactants useful in the compositions of the present invention are disclosed in McCutcheon's, Detergents and Emulsifiers, North American edition (1986), published by allured Publishing Corporation; McCutcheon's, Functional Materials, North American Edition (1992); and U.S. Pat. No. 3,929,678, to Laughlin et al., issued Dec. 30, 1975, all of which are incorporated by reference herein in their entirety. A wide variety of anionic lathering surfactants are useful herein. Non-limiting examples of anionic lathering surfactants include those selected from the group consisting of sarcosinates, sulfates, isethionates, taurates, phosphates, lactylates, glutamates, and mixtures thereof.

Non-limiting examples of nonionic lathering surfactants and amphoteric surfactants for use in the compositions of the present invention are disclosed in McCutcheon's, Detergents and Emulsifiers, North American edition (1986), published by allured Publishing Corporation; and McCutcheon's, Functional Materials, North American Edition (1992); both of which are incorporated by reference herein in their entirety.

Non-ionic lathering surfactants useful herein include those selected from the group consisting of alkyl glucosides, alkyl polyglucosides, polyhydroxy fatty acid amides, alkoxylated fatty acid esters, lathering sucrose esters, amine oxides, and mixtures thereof.

The term “amphoteric lathering surfactant,” as used herein, is also intended to encompass zwitterionic surfactants, which are well known to formulators skilled in the art as a subset of amphoteric surfactants.

A wide variety of amphoteric lathering surfactants can be used in the compositions of the present invention. Particularly useful are those which are broadly described as derivatives of aliphatic secondary and tertiary amines, preferably wherein the nitrogen is in a cationic state, in which the aliphatic radicals can be straight or branched chain and wherein one of the radicals contains an ionizable water solubilizing group, e.g., carboxy, sulfonate, sulfate, phosphate, or phosphonate. Non-limiting examples of amphoteric or zwitterionic surfactants are those selected from the group consisting of betaines, sultaines, hydroxysultaines, alkyliminoacetates, iminodialkanoates, aminoalkanoates, and mixtures thereof.

Additional compositions utilized in accordance with the present invention can comprise a wide range of optional ingredients. The CTFA International Cosmetic ingredient Dictionary, Sixth Edition, 1995, which is incorporated by reference herein in its entirety, describes a wide variety of non-limiting cosmetic and pharmaceutical ingredients commonly used in the skin care industry, which are suitable for use in the compositions of the present invention. Non-limiting examples of functional classes of ingredients are described at page 537 of this reference. Examples of these functional classes include: abrasives, anti-acne agents, anti-caking agents, antioxidants, binders, biological additives, bulking agents, chelating agents, chemical additives, natural additives, colorants, cosmetic astringents, cosmetic biocides, degreasers, denaturants, drug astringents, emulsifiers, external analgesics, film formers, fragrance components, humectants, opacifying agents, plasticizers, preservatives, propellants, reducing agents, skin bleaching agents, skin-conditioning agents (emollient, humectants, miscellaneous, and occlusive), skin protectants, solvents, foam boosters, hydrotropes, solubilizing agents, suspending agents (nonsurfactant), sunscreen agents, ultraviolet light absorbers, and viscosity increasing agents (aqueous and nonaqueous). Examples of other functional classes of materials useful herein that are well known to one of ordinary skill in the art include solubilizing agents, sequestrants, and keratolytics, and the like.

The aforementioned classes of ingredients are incorporated in a safe and effective amount. The term “safe and effective amount” as used herein, means an amount of an active ingredient high enough to modify the condition to be treated or to deliver the desired skin benefit, but low enough to avoid serious side effects, at a reasonable benefit to risk ratio within the scope of sound medical judgment.

In addition to home care and personal care end uses, the nonwoven cleaning article may be used in industrial and medical applications. For instance, the article may be useful in paint preparation and cleaning outdoor surfaces, such as lawn furniture, grills, and outdoor equipment, wherein the low Tinting attributes of the laminate may be desirable. Aqueous or non-aqueous functional industrial solvents include, oils, such as plant oils, animal oils, terpenoids, silicon oils, mineral oils, white mineral oils, paraffinic solvents, polybutylenes, polyisobutylenes, polyalphaolefins, and mixtures thereof, toluenes, sequestering agents, corrosion inhibitors, abrasives, petroleum distillates, and the combinations thereof.

A medical cleaning article may incorporate an antimicrobial composition, including, but not limited to iodines, alcohols, such as such as ethanol or propanol, biocides, abrasives, metallic materials, such as metal oxide, metal salt, metal complex, metal alloy or mixtures thereof, bacteriostatic complexes, bactericidal complexs, and the combinations thereof.

The cleaning article of the present invention is particularly suitable for dispensing from a tub of stacked, folded wipes, or for dispensing as “pop-up” wipes, in which the cleaning article is stored in the tub as a perforated continuous roll, wherein upon pulling a wipe out of the tub, an edge of the next wipe is presented for easy dispensing. The wipes of the present invention can be folded in any of various known folding patterns, such as C-folding, but is preferably Z-folded. A Z-folded configuration enables a folded stack of wipes to be interleaved with overlapping portions. The cleaning article may be packaged in various convenient forms, whereby the method of packaging is not meant to be a limitation of the present invention.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

1. A method of making a nonwoven home care cleaning article comprising the steps of:
a. providing a nonwoven fabric, wherein said nonwoven fabric is subject to hydraulic energy upon a three-dimensional image transfer device so as to simultaneously entangle and impart at least a first three-dimensional image and a second three-dimensional image into said fabric forming a nonwoven fabric with intercalated three-dimensional images; and
b. a cleansing composition comprising an effective amount of a cleansing surfactant, said aqueous liquid cleansing composition being coated onto or impregnated into said substrate to the extent of from 50% to 500% by weight of the substrate.

2. A method of making a nonwoven home care cleaning article as in claim 1, wherein said cleansing composition is an aqueous or non-aqueous composition.

3. A method of making a nonwoven home care cleaning article as in claim 1, wherein said cleansing composition is selected from the group consisting of alkylpolysaccharides, alkyl ethoxylates, alkyl sulfonates, organic solvents, mono- or polycarboxylic acids, odor control agents, peroxides, hydrogen peroxides, thickening polymers, aqueous solvent systems, suds suppressors, perfumes or fragrances, detergent adjuvants, buffers, preservatives, antibacterial agents, colorants, bleaching agents, abrasive compounds, degreasers, chelants, enzymes, hydrotropes, and the combinations thereof.

4. A method of making a nonwoven personal care cleaning article comprising the steps of:
a. providing a nonwoven fabric, wherein said nonwoven fabric is subject to hydraulic energy upon a three-dimensional image transfer device so as to simultaneously entangle and impart at least a first three-dimensional image and a second three-dimensional image into said fabric forming a nonwoven fabric with intercalated three-dimensional images; and
b. a cleansing composition comprising an effective amount of a cleansing surfactant, said aqueous liquid cleansing composition being coated onto or impregnated into said substrate to the extent of from 50% to 500% by weight of the substrate.

5. A method of making a nonwoven personal care cleaning article as in claim 4, wherein said cleansing composition is an aqueous or non-aqueous composition.

6. A method of making a nonwoven personal care cleaning article as in claim 4, wherein said cleansing composition is selected from the group consisting of abrasives, anti-acne agents, anti-caking agents, antioxidants, binders, biological additives, bulking agents, chelating agents, chemical additives, natural additives, colorants, vitamins, cosmetic astringents, cosmetic biocides, denaturants, drug astringents, emulsifiers, external analgesics, film formers, fragrance components, humectants, emollients, opacifying agents, plasticizers, preservatives, propellants, reducing agents, skin bleaching agents, skin-conditioning agents, skin protectants, solvents, foam boosters, hydrotropes, solubilizing agents, suspending agents, sunscreen agents, ultraviolet light absorbers, viscosity increasing agents, and the combinations thereof.

7. A method of making a nonwoven industrial cleaning article comprising the steps of:
a. providing a nonwoven fabric, wherein said nonwoven fabric is subject to hydraulic energy upon a three-dimensional image transfer device so as to simultaneously entangle and impart at least a first three-dimensional image and a second three-dimensional image into said fabric forming a nonwoven fabric with intercalated three-dimensional images; and
b. a cleansing composition comprising an effective amount of a cleansing surfactant, said aqueous liquid cleansing composition being coated onto or impregnated into said substrate to the extent of from 50% to 500% by weight of the substrate.

8. A method of making a nonwoven industrial cleaning article as in claim 7, wherein said cleansing composition is an aqueous or non-aqueous composition.

9. A method of making a nonwoven industrial cleaning article as in claim 7, wherein said cleansing composition is a solvent selected from the group consisting of oils, paraffinic solvents, polybutylenes, polyisobutylenes, polyalphaolefins, toluenes, sequestering agents, corrosion inhibitors, abrasives, petroleum distillates, and the combinations thereof.

10. A method of making a nonwoven medical cleaning article comprising the steps of:
a. providing a nonwoven fabric, wherein said nonwoven fabric is subject to hydraulic energy upon a three-dimensional image transfer device so as to simultaneously entangle and impart at least a first three-dimensional image and a second three-dimensional image into said fabric forming a nonwoven fabric with intercalated three-dimensional images; and
b. a cleansing composition comprising an effective amount of a cleansing surfactant, said aqueous liquid cleansing composition being coated onto or impregnated into said substrate to the extent of from 50% to 500% by weight of the substrate.

11. A method of making a nonwoven medical cleaning article as in claim 10, wherein said cleansing composition is an aqueous or non-aqueous composition.

12. A method of making a nonwoven medical cleaning article as in claim 10, wherein said cleansing composition is selected from the group consisting of iodines, alcohols, biocides, abrasives, metallic materials, bacteriostatic complexes, bactericidal complexes, and the combinations thereof.
